(19) United States
(12) Patent Application Publication
(10) Pub. No.: US 2022/0126991 A1
(43) Pub. Date: Apr. 28, 2022

(54) BIASED TENSION-TORSION STRAP

(71) Applicant: Bell Textron Inc., Fort Worth, TX (US)

(72) Inventors: Aaron Alexander Acee, Flower Mound, TX (US); Andrew Paul Haldeman, Fort Worth, TX (US); Paul Wayne Woolbright, Euless, TX (US); Timothy McClellan Mosig, Richland Hills, TX (US)

(21) Appl. No.: 17/082,601

(22) Filed: Oct. 28, 2020

(51) Int. Cl. B64C 27/35; B64C 27/48

(52) U.S. Cl. CPC B64C 27/35; B64C 27/33; B64C 27/48

(57) ABSTRACT

A rotor system includes a drive hub, a set of rotor blades extending radially from the drive hub, and a set of tension-torsion straps connecting the rotor blades to the drive hub. The drive hub has a rotor mast opening extending along a mast axis. The rotor system is configured to rotate about the mast axis. The drive hub further has a set of mounting slots for mounting the tension-torsion straps. The mounting slots are arranged along a circle around the drive hub, each mounting slot extending through the drive hub along a respective mounting axis. The mounting axis of each of the mounting slots is biased relative to the mast axis. The tension-torsion straps are mounted to the drive hub at their corresponding mounting slots.

### TECHNICAL FIELD

This disclosure relates in general to the field of rotor systems and, more particularly, to a tension-torsion strap attached at a bias angle to a drive hub of a rotor.

### BACKGROUND

Some aircraft rotor systems use tension-torsion straps to hold rotor blades to a drive hub. During rotation of the rotor, the tension-torsion straps counter the centrifugal forces on the rotor blades. Tension-torsion straps are particularly useful in rotors in which the blades can change pitch because the tension-torsion straps provide a flexible connection that can twist with the rotor blades. Tension-torsion straps are typically connected to the blades at a neutral blade angle (e.g., zero blade angle), and at this neutral blade angle the tension-torsion straps are flat relative to the drive hub. When the pitch of the rotor blades changes from the neutral blade angle, the tension-torsion straps physically twist with the rotor blades.

### SUMMARY

One embodiment is a rotor system that includes a drive hub, rotor blades, and tension-torsion straps. The drive hub includes a rotor mast opening extending through the drive hub along a mast axis, the rotor system configured to rotate about the mast axis. The drive hub also includes mounting slots for mounting tension-torsion straps. The mounting slots are arranged along a circle around the drive hub, and each mounting slot extends through the drive hub along a respective mounting axis, where the mounting axis of each of the mounting slots is biased relative to the mast axis. The rotor blades extend radially from the drive hub. The tension-torsion straps connect the rotor blades to the drive hub, and each tension-torsion strap is mounted to the drive hub at a corresponding mounting slot.

In some examples, each of the mounting slots includes an upper hub opening and a lower hub opening, and a mounting bolt is configured to fit through the upper hub opening, one of the tension-torsion straps, and the lower hub opening to fasten the tension-torsion strap to the drive hub. A center point of the upper hub opening and a center point of the lower hub opening may be located at a same distance from the mast axis.

In some examples, the rotor system is configured to angle the rotor blades at a range of positions along an asymmetric blade pitch envelope, the asymmetric blade pitch envelope having a maximum blade angle and a minimum blade angle, and the maximum blade angle having a greater magnitude than the minimum blade angle. The asymmetric blade pitch envelope has a midpoint blade angle midway between the maximum blade angle and the minimum blade angle, and an angle of the mounting axis relative to the mast axis may correspond to the midpoint blade angle. When the rotor blades rotate while positioned at the maximum blade angle, the rotor blades apply a first load to the tension-torsion straps, and when the rotor blades rotate while positioned at the minimum blade angle, the rotor blades apply a second load to the tension-torsion straps. An angle of the mounting axis relative to the mast axis may be selected such that the first load and the second load have approximately equal magnitude.

In some examples, the angle of the mounting axis relative to the mast axis is at least 5°. In some examples, the angle of the mounting axis relative to the mast axis is at least 10°. In some examples, the angle of the mounting axis relative to the mast axis is greater than 15° and less than 20°.

Another embodiment is a drive hub that includes a rotor mast opening and a plurality of mounting slots for mounting tension-torsion straps to the drive hub. The rotor mast opening extends through a center of the drive hub along a mast axis. The plurality of mounting slots are arranged in a circle around the drive hub. Each mounting slot extends through the drive hub along a respective mounting axis, and the mounting axis of each mounting slot is biased at an angle of at least 5° relative to the mast axis.

In some examples, each of the mounting slots includes an upper hub opening and a lower hub opening, and a corresponding mounting bolt is configured to fit through the upper hub opening, one of the tension-torsion straps, and the lower hub opening to fasten the tension-torsion strap to the drive hub. A center point of the upper hub opening and a center point of the lower hub opening may be located at a same distance from the mast axis.

In some examples, the angle of the mounting axis relative to the mast axis is at least 10°. In some examples, the angle of the mounting axis relative to the mast axis is greater than 15° and less than 20°.

Another embodiment is an aircraft with a ducted rail rotor, the ducted tail rotor including a drive hub, a plurality of rotor blades extending radially from the drive hub, a plurality of tension-torsion straps connecting the rotor blades to the drive hub, and a duct surrounding the drive hub and the plurality of rotor blades. The drive hub includes a rotor mast opening extending through the drive hub along a mast axis, the drive hub configured to rotate about the mast axis. The drive hub also includes mounting slots for mounting tension-torsion straps. The mounting slots are arranged along a circle around the drive hub, and each mounting slot extends through the drive hub along a respective mounting axis, where the mounting axis of each of the mounting slots is biased relative to the mast axis. Each tension-torsion strap is mounted to the drive hub at a corresponding mounting slot.

In some examples, each of the mounting slots includes an upper hub opening and a lower hub opening, and a mounting bolt is configured to fit through the upper hub opening, one of the tension-torsion straps, and the lower hub opening to fasten the tension-torsion strap to the drive hub. A center point of the upper hub opening and a center point of the lower hub opening may be located at a same distance from the mast axis.

In some examples, the ducted tail rotor is configured to angle the rotor blades at a range of positions along an asymmetric blade pitch envelope, the asymmetric blade pitch envelope having a maximum blade angle and a minimum blade angle, and the maximum blade angle having a greater magnitude than the minimum blade angle. The asymmetric blade pitch envelope has a midpoint blade angle midway between the maximum blade angle and the minimum blade angle, and an angle of the mounting axis relative to the mast axis may correspond to the midpoint blade angle. When the rotor blades rotate while positioned at the maximum blade angle, the rotor blades apply a first load to the tension-torsion straps, and when the rotor blades rotate while positioned at the minimum blade angle, the rotor blades apply a second load to the tension-torsion straps. An angle of the mounting axis relative to the mast axis may be selected such that the first load and the second load have approximately equal magnitude.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIG. 1 illustrates a side view of an example aircraft having one or more rotor systems employing biased tension-torsion straps in accordance with certain embodiments of the present disclosure;

FIG. 2 illustrates a front plan view of the aircraft shown in FIG. 1;

FIG. 3 illustrates the primary rotor system of the aircraft shown in FIG. 1 with blades in a neutral position;

FIG. 4 illustrates the primary rotor system of the aircraft shown in FIG. 1 with the blades pitched at an angle;

FIG. 5 is a top isometric view of a rotor system in accordance with embodiments described herein;

FIG. 6 is a lower isometric view of the rotor system shown in FIG. 5 in accordance with embodiments described herein;

FIG. 7 is a detailed view of a drive hub of a rotor in accordance with embodiments described herein;

FIG. 8 is a cross-section of a portion of the drive hub shown in FIG. 7 with a biased tension-torsion strap attached to a mounting slot in accordance with embodiments described herein; and

FIG. 9 is a front view of the drive hub shown in FIG. 7 with the biased tension-torsion strap attached in accordance with embodiments described herein.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, depth, etc.) of an element, operations, and/or conditions, the phrase “between X and Y” represents a range that includes X and Y.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying FIGURES.

Embodiments described herein provide a tension-torsion strap that is attached at a bias angle to a drive hub of a rotor, and a drive hub configured to mount tension-torsion straps at a bias angle. In a rotor system, tension-torsion straps attach the rotor blades to the drive hub of the rotor. The tension-torsion straps counter centrifugal forces on the rotor blades during operation of the rotor system. The tension-torsion straps are flexible, which allows the tension-torsion straps to twist when the rotor blades change pitch.

In prior rotor assemblies that use tension-torsion straps, the tension-torsion straps are bolted to drive hub by bolts that extend straight through the drive hub. When the rotor blades were at a neutral position (e.g., rotor blades lie along a plane oriented perpendicular to a mast axis through the rotor), the tension-torsion straps were also at a neutral, untwisted position. Rotor blades often can pitch in both directions relative to the neutral position, e.g., pitching upward with a positive blade angle, or pitching downward with a negative blade angle. The range of blade angles available to the rotor or used by the rotor during typical operation is often not symmetric. For example, a rotor system may have a minimum blade angle of −25° and a maximum blade angle of 50°. In other words, the blades have a higher maximum pitch magnitude in one direction than in the other direction.

The loads on the tension-torsion straps typically increase as the pitch magnitude increases, and, in turn, the amount of twisting experienced by the tension-torsion strap increases. While the loads on the tension-torsion straps are determined by multiple factors and control forces, they often follow a generally linear pattern, with the minimum load at or near the neutral, untwisted position. For example, for a tension-torsion strap attached at a neutral 0° blade angle, a load applied by the rotation of blades pitched at −25° is often similar to the load applied by the rotation of blades pitched at 25°. If the blades can pitch further in one direction than the other, this causes the tension-torsion strap to experience a higher load in one direction (e.g., at the maximum blade angle of 50°) than in the other direction (e.g., at the minimum blade angle of −25°).

The drive hub described herein provides angled tension-torsion strap mounting slots so that the tension-torsion straps are attached at a bias angle relative to the drive hub. Biasing the tension-torsion straps reduces the maximum load that is applied to the tension-torsion straps. As one example, rather than securing the tension-torsion straps so that they are at a neutral, untwisted position when the rotor blades are at a neutral position (as described above), the tension-torsion straps are secured at a 12.5° bias angle. When the rotor blades are pitched to the minimum blade angle of −25°, the total twist on the tension-torsion straps is −37.5°. When the rotor blades are pitched to the maximum blade angle of 50°, the total twist on the tension-torsion straps is +37.5°. If the loads applied to the tension-torsion strap follows a linear (or otherwise symmetric) pattern centered around a 0° twist in the tension-torsion strap, the bias angle causes the load applied to the tension-torsion straps at the maximum blade angle (50)° to be the same as, or similar to, the load applied to the tension-torsion straps at the minimum blade angle (−25°).

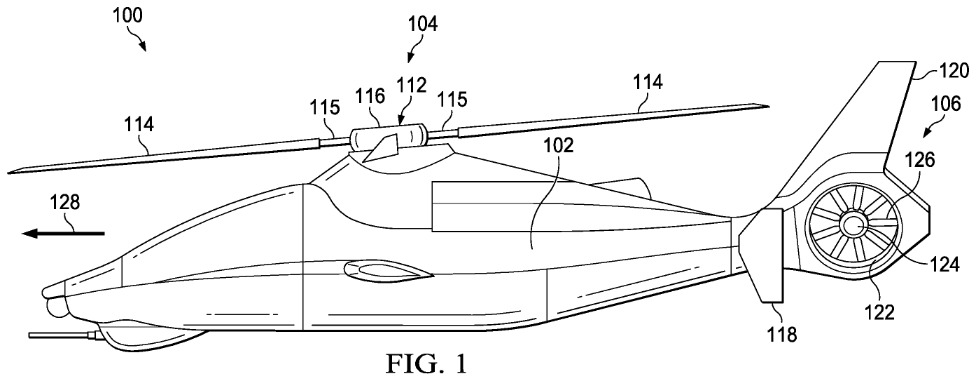

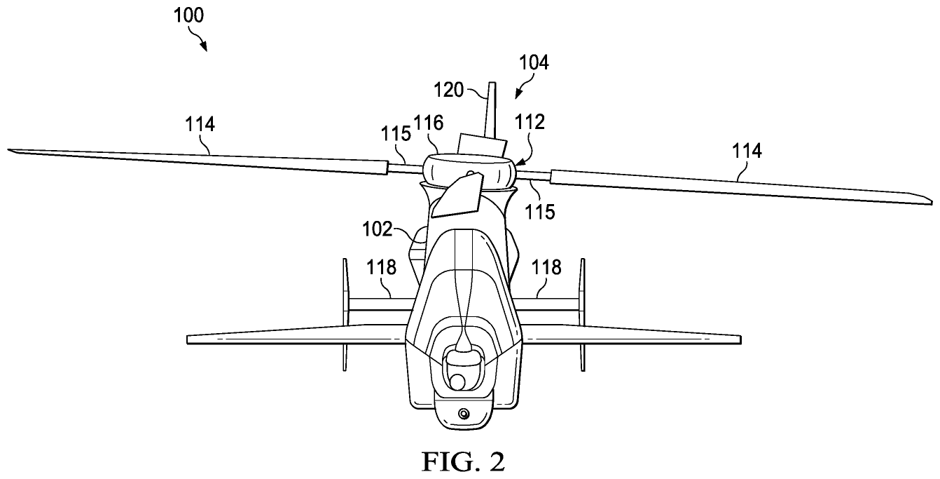

Referring to FIGS. 1 and 2, illustrated therein are different views (i.e., a side view and a front view, respectively) of an example embodiment of an aircraft, which in the illustrated example is a rotorcraft 100. As shown in FIGS. 1 and 2, rotorcraft 100 includes a fuselage 102, a primary rotor system 104, and an empennage 106. The fuselage 102 is the main body of the rotorcraft 100, which may include a cabin (e.g., for crew, passengers, and/or cargo) and/or may house certain mechanical components, electrical components, etc. (e.g., engine(s), transmission, flight controls, etc.).

The rotor system 104 is used to generate lift for rotorcraft 100. For example, the rotor system 104 (also generally referred to as the “rotor”) may include a rotor hub 112 (also referred to as a “rotor hub assembly” or more generally as a “hub”) coupled to a plurality of rotor blades 114 (also referred to generally as “blades”) that extend radially from the rotor hub 112 via blade extensions 115. Torque generated by the engine(s) of the rotorcraft causes the rotor blades 114 to rotate, which generates lift. In accordance with features of embodiments disclosed herein, the rotor hub 112 is completely shrouded by a rotor hub fairing 116.

The empennage 106 of the rotorcraft 100 includes a horizontal stabilizer 118, a vertical stabilizer 120, and a tail rotor or anti-torque system 122. Although not shown in the view illustrated in FIG. 1, a corresponding horizontal stabilizer is disposed on the other side of the rotorcraft 100 opposite the horizontal stabilizer 118. The horizontal stabilizer 118 and vertical stabilizer 120 respectively provide horizontal and vertical stability for the rotorcraft 100. Moreover, tail rotor or anti-torque system 122 may be used to provide anti-torque and/or direction control for the rotorcraft 100. The tail rotor in the example shown in FIG. 1 is a ducted tail rotor that includes a hub 124 and blades 126 extending radially from the hub 124. The tail rotor system 122 is surrounded by a duct.

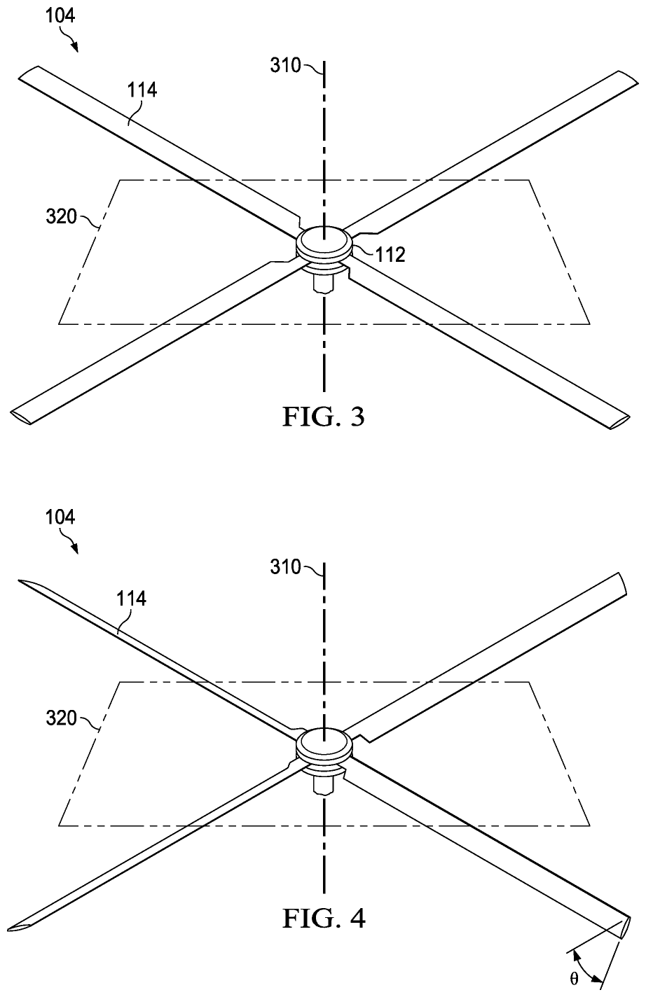

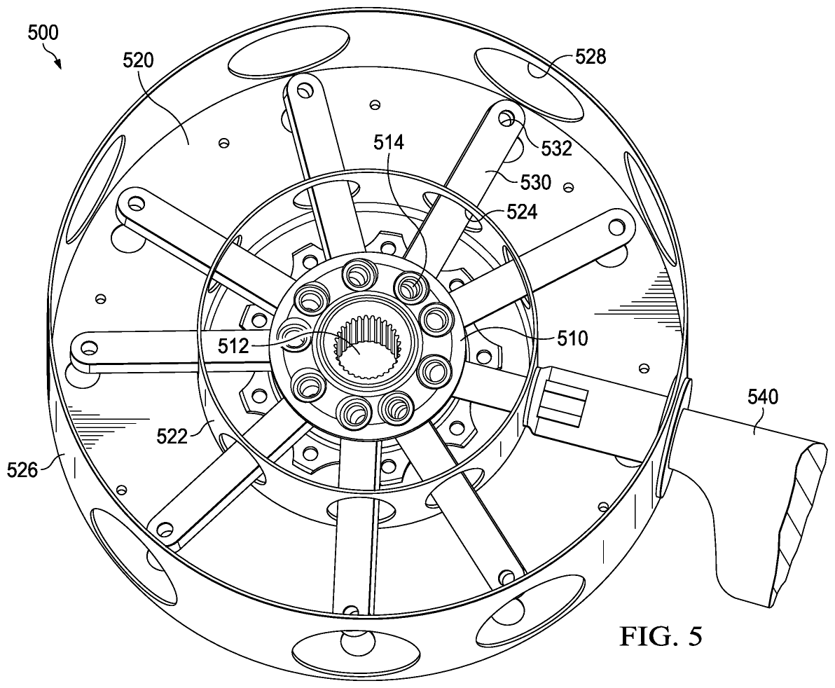

Rotorcraft 100 relies on rotor system 104 for flight capabilities, such as controlling (e.g., managing and/or adjusting) flight direction, thrust, and lift of the rotorcraft. For example, the pitch of each rotor blade 114 can be controlled using collective control or cyclic control to selectively control direction, thrust, and lift of the rotorcraft 100. During collective control, all of the rotor blades 114 are collectively pitched together (e.g., the pitch angle is the same for all blades), which affects overall thrust and lift. During cyclic control, the pitch angle of each of the rotor blades 114 varies depending on where each blade is within a cycle of rotation (e.g., at some points in the rotation the pitch angle is not the same for all blades), which can affect direction of travel of the rotorcraft 100. An example of the rotor blades 114 pitched under collective control is shown in FIGS. 3 and 4.

Aircraft such as rotorcraft 100 can be subjected to various aerodynamic and operational forces during operation, such as lift, drag, centrifugal force, aerodynamic shears, and so forth. Lift and centrifugal force, for example, are forces produced by the rotation of a rotor system. Lift is an upward force that allows a rotorcraft to elevate, while centrifugal force is a lateral force that tends to pull the rotor blades outward from the rotor hub. These forces can subject the rotor hub, rotor yoke, and/or the rotor blades (referred to herein using the terms “hub/blades”, “yoke/blades”, “hub/yoke/blades”, and variations thereof) to flapping, leading and lagging, and/or bending. For example, flapping is a result of the dissymmetry of lift produced by rotor blades at different positions (typically referred to as “pitch” or “pitch angles”) during a single rotation. During rotation, for example, a rotor blade may generate more lift while advancing in the direction of travel of the rotorcraft than while retreating in the opposite direction. A rotor blade may be flapped up (also sometimes referred to as being pitched “nose-up”) while advancing in the direction of travel, and may flap down (e.g., pitched “nose-down”) while retreating in the opposite direction. When a blade is pitched more nose-up, more lift is created on that blade, which will drag the side of the rotor/hub upward, which makes the hub/yoke flap. For example, for rotorcraft 100, the most aft blade (e.g., nearest to tail rotor or anti-torque system 122) of the rotor system 104 may be pitched more nose-up and the most forward blade may be pitched more nose-down; to provide a forward direction of travel (as generally indicated by arrow 128) for rotorcraft 100.

FIGS. 3 and 4 show two example blade pitches of the primary rotor system 104 shown in FIG. 1. FIG. 3 shows the primary rotor system 104 with the rotor blades 114 in a neutral position. A rotor mast fits into the rotor hub 112 along the mast axis 310 to rotate the blades 114 about the mast axis 310. A neutral blade plane 320 perpendicular to the mast axis 310 is illustrated in FIG. 3. In the arrangement shown in FIG. 3, the blades 114 lay flat along the neutral blade plane 320. The rotor hub 112 can change the pitch of the blades 114 such that the blades pitch upwards or downwards, away from their neutral position. In the arrangement shown in FIG. 4, the blades 114 are pitched downwards at an angle θ relative to the neutral blade plane 320. For example, θ may be a minimum blade angle, i.e., the most downward pitch available to and/or used by the rotor hub 112. The rotor hub 112 can also pitch the blades in the opposite, upward direction, up to a maximum blade angle, i.e., the highest upward pitch available to and/or used by the rotor hub 112. The range of pitch angles is also referred to as a pitch envelope. As discussed above, the minimum blade angle and maximum blade angle may have different magnitudes, e.g., the rotor system 104 may have a minimum blade angle of −25° and a maximum blade angle of 50°. This blade pitch envelope is merely exemplary; in other embodiments, different minimum blade angles and maximum blade angles may be used.

While FIGS. 3 and 4 demonstrate pitching of primary rotor system 104, other rotor systems can pitch in a similar manner. For example, the tail rotor system 122 includes a set of rotor blades 126 connected to a rotor hub 124 that rotates about a mast axis through the center of the rotor hub 124. In a neutral position, the rotor blades 126 are along a neutral blade plane that is perpendicular to the mast axis of the rotor hub 124. The rotor hub 124 controls the pitch angle of the rotor blades 126 in a similar manner; in particular, the rotor system 122 has a pitch envelope bounded by a minimum blade angle and a maximum blade angle, and the rotor hub 124 can pitch the rotor blades 126 to different positions within this pitch envelope.

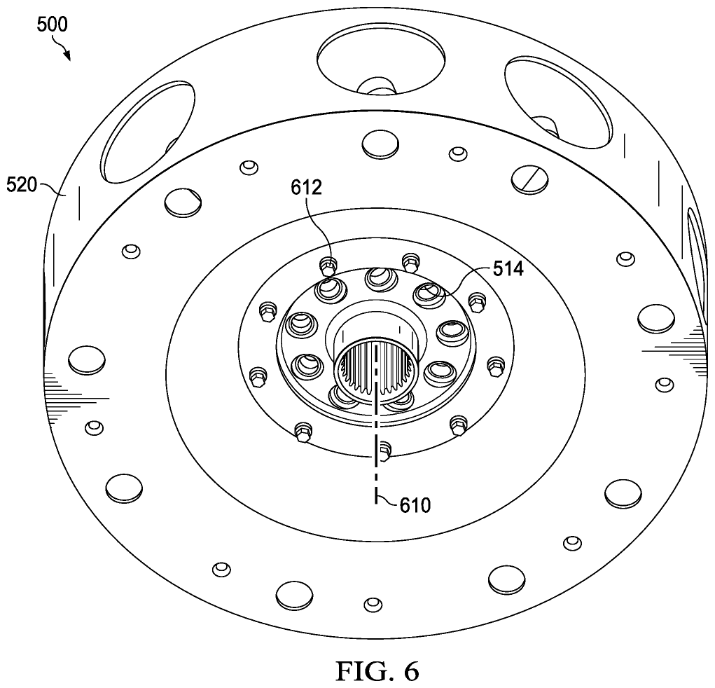

FIGS. 5 and 6 are upper and lower isometric cutaway views of a rotor hub 500. The rotor hub 500 may be an example of the primary rotor hub 112 or the tail rotor hub 124 shown in FIG. 1. In other examples, the rotor hub 500 may be a rotor hub for another application, e.g., a hub of a propeller of a fixed wing aircraft or a tiltrotor aircraft. The rotor hub 500 includes a drive hub 510, a hub housing 520, and tension-torsion straps 530. One example blade 540 is shown fitted into the rotor hub 500 and connected to one of the tension-torsion straps 530. FIG. 5 shows certain components of the rotor hub 500 while other components are not depicted. For example, the rotor hub 500 includes additional components not shown in FIG. 5 for controlling the pitch of the blades 540, such as a pitch spider and pitch horn joints that connect the pitch spider to the blades 540.

The drive hub 510 includes a mast opening 512 that extends through the drive hub 510 along a mast axis, e.g., the mast axis 310 shown in FIGS. 3 and 4. FIG. 6 depicts a mast axis 610 extending through the mast opening 512. A mast (not shown in FIGS. 5 and 6) is attached to the mast opening 512. The mast rotates the drive hub 510 about the mast axis 610, and the drive hub 510 rotates the blades 540 connected to the drive hub 510 about the mast axis 610.

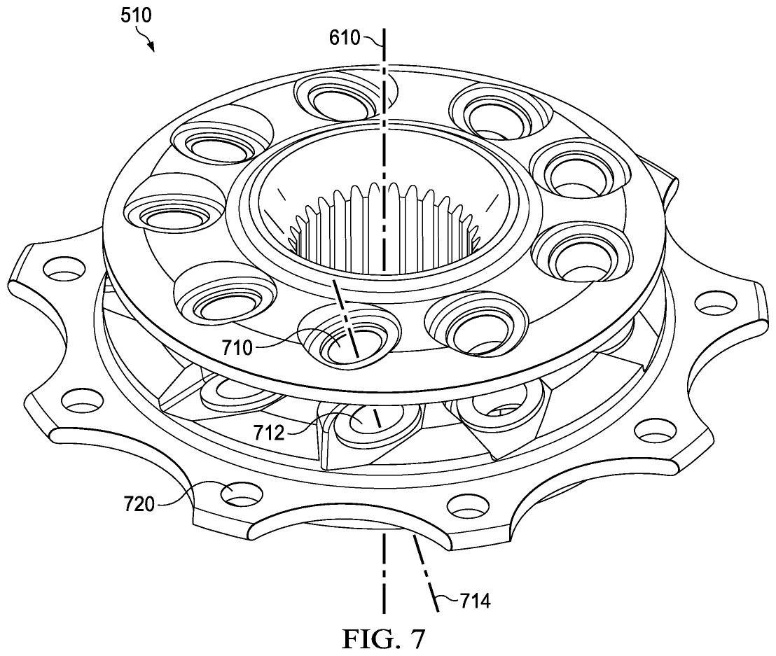

The drive hub 510 also includes a set of mounting slots 514 for mounting the tension-torsion straps 530. FIG. 5 shows the upper ends of the mounting slots 514 extending through a top side of the drive hub 510, and FIG. 6 shows the lower ends of the mounting slots 514 extending through a bottom side of the drive hub 510. The mounting slots 514 are arranged along a circle around the drive hub 510; the circle formed by the mounting slots 514 is centered on the mast axis 610. Each mounting slot extends through the drive hub 510 along a respective mounting axis that is biased relative to the mast axis. FIGS. 7 and 9 show the drive hub 510 in greater detail and show an example mounting axis through one of the mounting slots 514.

A hub housing 520 surrounds the drive hub 510. The hub housing 520 is connected to the drive hub 510 via bolts 612 shown in FIG. 6. Returning to FIG. 5, the hub housing 520 includes an inner ring 522 that encircles the drive hub 510. The hub housing 520 also includes an outer ring 526 that encircles the inner ring 522, the tension-torsion straps 530, and a portion of the blades 540, e.g., the blade roots. Each of the inner rings 522 and 526 include a series of openings 524 and 528 therethrough. The tension-torsion straps 530 extend from the drive hub 510 through the inner blade openings 524 to attach to the blades 540. The blades extend from the inner blade openings 524 through outer blade openings 528 and out through the hub housing 520. The blades 540 revolve within the inner blade openings 524 and outer blade openings 528 as the blades 540 change pitch.

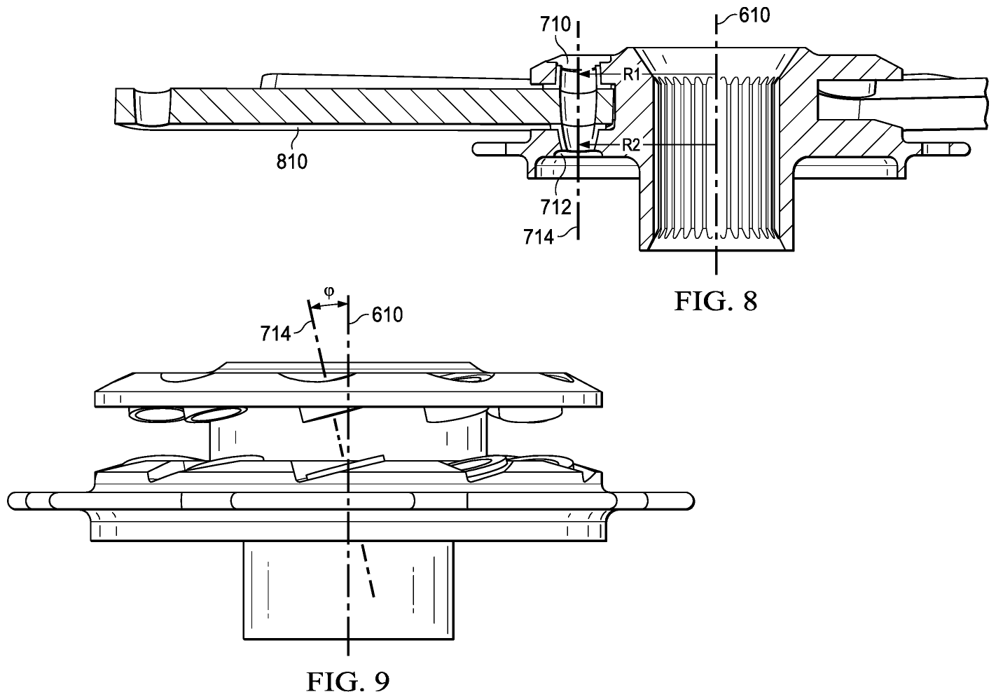

The tension-torsion straps 530 connect the rotor blades 540 to the drive hub 510. Each tension-torsion strap 530 is mounted to the drive hub 510 at a corresponding mounting slot 514. Each tension-torsion strap 530 has an opening at each end to fasten the tension-torsion strap 530 to the drive hub 510 and to the corresponding blade 540. A blade opening 532 for joining the tension-torsion strap 530 to a blade 540 is shown in FIG. 5. The tension-torsion strap 530 has a similar opening at the end closer to the drive hub 510. A bolt (not shown in FIG. 5) slots through the opening at the hub end and a mounting slot 514 to fasten the tension-torsion strap 530 to the drive hub 510. A cross section showing a bolt fastening a tension-torsion strap 530 to the drive hub is shown in FIG. 8.

In some embodiments, rather than having two distinct openings, the tension-torsion strap 530 has a single opening that extends from a portion of the opening that attaches to the drive hub 510 and another portion that attaches to the blade 540. In another embodiment, the tension-torsion strap 530 has the blade opening 532 and the hub mounting opening, and another opening extending through a portion of the length of the tension-torsion strap 530 between the blade opening 532 and the hub mounting opening. Other designs for the tension-torsion strap may be used.

The tension-torsion straps 530 are flexible and able to twist when the blades 540 change pitch. The tension-torsion straps 530 may be composed of any material or combination of materials allow twisting movement but have a high tensile strength to prevent stretching. For example, the tension-torsion straps 530 may be composed of steel wires, synthetic fibers, stacked metallic layers, or stacked fiberglass layers. In some embodiments, the tension-torsion straps 530 have a casing composed of rubber, urethane, or another material or combination of materials.

In the view shown in FIG. 5, the tension-torsion straps 530 are in a neutral, untwisted position. The blade 540 shown in FIG. 5 is not at its neutral, flat position. Instead, the blade 540 is pitched at an angle that corresponds to the mounting angle of the tension-torsion straps 530. For example, if a bias angle of the mounting slots 514 is 10°, the blade 540 is pitched 10° when the tension-torsion straps 530 are untwisted. For a blade 540 to be in its neutral, flat position, i.e., the position shown in FIG. 3, the tension-torsion strap 530 connected to the blade is twisted away from its neutral position, e.g., the tension-torsion strap 530 twists by 10° if the bias angle is 10° to put the blade 540 in its flat, neutral position. As discussed above, a pitch spider and pitch horn joint (not shown in FIG. 5) or another blade pitching mechanism may control the pitch of the blades 540 and, in turn, control the twisting of the tension-torsion straps 530.

FIG. 7 is a detailed view of the drive hub 510. FIG. 7 shows the mounting slots 514 for mounting the tension-torsion straps to the drive hub 510 at a bias in greater detail. Each mounting slot 514 has an upper hub opening 710 and a lower hub opening 712. Each of the hub openings 710 and 712 are typically circular, as depicted. An end of the tension-torsion strap 530 fits between the upper hub opening 710 and the lower hub opening 720, as shown in FIGS. 5 and 8. A mounting axis 714 extends through a midpoint of the upper hub opening 710 and a midpoint of the lower hub opening 712, along the center line of a bolt that fits through the mounting slot 514. As shown in FIG. 7, the mounting axis 714 is biased relative to the mast axis 610. FIG. 7 also shows hub housing mounting openings 720 extending in a circle around the drive hub 510. The bolts 612 shown in FIG. 6 extend through the hub housing mounting openings 720 to fasten the hub housing 520 to the drive hub 510.

FIG. 8 is a cross-section of a portion of the drive hub 510 shown in FIG. 7. As shown in FIG. 8, one end of the tension-torsion strap 530 is sandwiched between the upper hub opening 710 and the lower hub opening 720. A mounting bolt fits through the upper hub opening 710, the tension-torsion strap 530, and the lower hub opening 720 to fasten the tension-torsion strap 530 to the drive hub 510. In the neutral, unflexed position of the tension-torsion strap 530, a lower side 810 of the tension-torsion strap 530 is visible when viewed straight-on, as in FIG. 8, because of the bias angle in the mounting slot 514. FIG. 8 shows a first distance R1 from the mast axis 610 to a center point of the upper hub opening 710, i.e., a point on the upper hub opening 710 along the mounting axis 714. FIG. 8 also shows a second distance R2 from the mast axis 610 to a center point of the lower hub opening 712, i.e., a point on the lower hub opening 712 along the mounting axis 714. In the example shown in FIG. 8, the two distances R1 and R2 are equal.

FIG. 9 is a front view of the drive hub shown in FIG. 7. FIG. 9 shows a front view of the mounting slot 514 and the mounting axis 714 therethrough. The mounting axis 714 is outboard of the mast axis 610, and an angle φ between the mounting axis 714 and the mast axis 610 is shown. As described with respect to FIGS. 3 and 4, the rotor system that includes the rotor hub 500 may be configured to angle the rotor blades 540 at a range of positions along a blade pitch envelope that is asymmetric, i.e., a blade pitch envelope in which the blades may pitch further in one direction than another, relative to a flat neutral position. For example, the blades 540 may pitch further in the forward direction (positive blade angle) than in the backward direction (negative blade angle).

The bias angle φ of the mounting axis 514 may be selected based on the blade pitch envelope. The bias angle φ may be at least 5°, or the bias angle φ may be at least 10°. In some embodiments, the bias angle φ is between 15° and 20°. In one embodiment, the bias angle φ corresponds to a midpoint of the asymmetric pitch envelope. For example, for a blade pitch envelope with a minimum pitch of −25° and a maximum pitch of 50°, the bias angle φ may be selected as 12.5°.

In another embodiment, the bias angle φ may be selected by modeling loads on the tension-torsion straps across the blade pitch envelope, and selecting the bias angle φ that results in loads that are the same or approximately the same at both ends of the blade pitch envelope. For example, a designer may calculate, for a range of possible bias angles, loads applied to the tension-torsion straps 530 when a rotor blade 540 is at its maximum pitch and when a rotor blade 540 is at its minimum pitch. The designer can select the bias angle φ such that the load applied when the rotor blade 540 is at its minimum pitch is equal or approximately equal to the load applied when the rotor blade 540 is at its maximum pitch. For example, the bias angle φ may be selected such that the load at the minimum pitch angle is within 5% or within 10% of the load at the maximum pitch angle.

It should be appreciated that the rotor assembly described herein can be used in various applications of rotors that use tension-torsion straps. Indeed, the various embodiments of the rotor assembly described herein may be used on any aircraft that utilizes rotors, such as helicopters, tiltrotor aircraft, hybrid aircraft, dual tiltrotor aircraft, unmanned aircraft, gyrocopters, airplanes, commuter aircraft, electric aircraft, hybrid-electric aircraft, ducted fan aircraft having any number of ducted fans, tiltwing aircraft, including tiltwing aircraft having one or more interwing linkages, more or fewer ducted fans or non-ducted rotors and the like.

Example 1 is a rotor system that includes a drive hub, a plurality of rotor blades extending radially from the drive hub, and a plurality of tension-torsion straps connecting the rotor blades to the drive hub. The drive hub includes a rotor mast opening extending through the drive hub along a mast axis, the rotor system configured to rotate about the mast axis. The drive hub also includes a plurality of mounting slots for mounting tension-torsion straps, the plurality of mounting slots arranged along a circle around the drive hub, each mounting slot extending through the drive hub along a respective mounting axis, where the mounting axis of each of the mounting slots is biased relative to the mast axis. Each of the plurality of tension-torsion straps is mounted to the drive hub at a corresponding mounting slot.

Example 2 provides the rotor system according to example 1, where each of the plurality of mounting slots includes an upper hub opening and a lower hub opening, and a mounting bolt is configured to fit through the upper hub opening, one of the plurality of tension-torsion straps, and the lower hub opening to fasten the tension-torsion strap to the drive hub.

Example 3 provides the rotor system according to example 2, where a center point of the upper hub opening and a center point of the lower hub opening are located at a same distance from the mast axis.

Example 4 provides the rotor system according to any of the preceding examples, where the rotor system is configured to angle the rotor blades at a range of positions along an asymmetric blade pitch envelope, the asymmetric blade pitch envelope having a maximum blade angle and a minimum blade angle, the maximum blade angle having a greater magnitude than the minimum blade angle.

Example 5 provides the rotor system according to example 4, where the asymmetric blade pitch envelope has a midpoint blade angle midway between the maximum blade angle and the minimum blade angle, and an angle of the mounting axis relative to the mast axis corresponds to the midpoint blade angle.

Example 6 provides the rotor system according to example 4, where the rotor blades, when rotating while positioned at the maximum blade angle, apply a first load to the tension-torsion straps; the rotor blades, when rotating while positioned at the minimum blade angle, apply a second load to the tension-torsion straps; and an angle of the mounting axis relative to the mast axis is selected such that the first load and the second load have approximately equal magnitude.

Example 7 provides the rotor system according to any of the preceding examples, where an angle of the mounting axis relative to the mast axis is at least 5°.

Example 8 provides the rotor system according to any examples 1 through 6, where an angle of the mounting axis relative to the mast axis is at least 10°.

Example 9 provides the rotor system according to any examples 1 through 6, where an angle of the mounting axis relative to the mast axis is greater than 15° and less than 20.

Example 10 provides a drive hub that includes a rotor mast opening extending through a center of the drive hub along a mast axis; and a plurality of mounting slots for mounting tension-torsion straps to the drive hub, the plurality of mounting slots arranged in a circle around the drive hub, each mounting slot extending through the drive hub along a respective mounting axis, where the mounting axis of each of the mounting slots is biased at an angle of at least 5° relative to the mast axis.

Example 11 provides the drive hub according to example 10, where each of the plurality of mounting slots includes an upper hub opening and a lower hub opening, and a corresponding mounting bolt is configured to fit through the upper hub opening, one of the plurality of tension-torsion straps, and the lower hub opening to fasten the tension-torsion strap to the drive hub.

Example 12 provides the drive hub according to example 11, where a center point of the upper hub opening and a center point of the lower hub opening are located at a same distance from the mast axis.

Example 13 provides the drive hub according to any of examples 10 through 12, where an angle of the mounting axis relative to the mast axis is at least 10°.

Example 14 provides the drive hub according to any of examples 10 through 12, where an angle of the mounting axis relative to the mast axis is greater than 15° and less than 20°.

Example 15 provides an aircraft comprising a ducted tail rotor, the ducted tail rotor comprising a drive hub, a plurality of rotor blades extending radially from the drive hub, a plurality of tension-torsion straps connecting the rotor blades to the drive hub, and a duct surrounding the drive hub and the plurality of rotor blades. The drive hub includes a rotor mast opening extending through the drive hub along a mast axis, the drive hub configured to rotate about the mast axis. The drive hub also includes a plurality of mounting slots for mounting tension-torsion straps, the plurality of mounting slots arranged along a circle around the drive hub, each mounting slot extending through the drive hub along a respective mounting axis, where the mounting axis of each of the mounting slots is biased relative to the mast axis. Each of the plurality of tension-torsion straps is mounted to the drive hub at a corresponding mounting slot.

Example 16 provides the aircraft according to example 15, where each of the plurality of mounting slots includes an upper hub opening and a lower hub opening, and a mounting bolt is configured to fit through the upper hub opening, one of the plurality of tension-torsion straps, and the lower hub opening to fasten the tension-torsion strap to the drive hub.

Example 17 provides the aircraft according to example 16, where a center point of the upper hub opening and a center point of the lower hub opening are located at a same distance from the mast axis.

Example 18 provides the aircraft according to any of examples 15 through 17, where the ducted tail rotor is configured to angle the rotor blades at a range of positions along an asymmetric blade pitch envelope, the asymmetric blade pitch envelope having a maximum blade angle and a minimum blade angle, the maximum blade angle having a greater magnitude than the minimum blade angle.

Example 19 provides the aircraft according to example 18, where the asymmetric blade pitch envelope has a midpoint blade angle midway between the maximum blade angle and the minimum blade angle, and an angle of the mounting axis relative to the mast axis corresponds to the midpoint blade angle.

Example 20 provides the aircraft according to example 18, where the rotor blades, when rotating while positioned at the maximum blade angle, apply a first load to the tension-torsion straps; the rotor blades, when rotating while positioned at the minimum blade angle, apply a second load to the tension-torsion straps; and an angle of the mounting axis relative to the mast axis is selected such that the first load and the second load have approximately equal magnitude.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure, but may or may not necessarily be combined in the same embodiments.

As used herein, unless expressly stated to the contrary, use of the phrase “at least one of”, “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first”, “second”, “third”, etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of”, “one or more of”, and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A rotor system comprising:
a drive hub comprising:
a rotor mast opening extending through the drive hub along a mast axis, the rotor system configured to rotate about the mast axis, and
a plurality of mounting slots for mounting tension-torsion straps, the plurality of mounting slots arranged along a circle around the drive hub, each mounting slot extending through the drive hub along a respective mounting axis, wherein the mounting axis of each of the mounting slots is biased relative to the mast axis;
a plurality of rotor blades extending radially from the drive hub; and
a plurality of tension-torsion straps connecting the rotor blades to the drive hub, each tension-torsion strap mounted to the drive hub at a corresponding mounting slot.

2. The rotor system of claim 1, wherein each of the plurality of mounting slots comprises an upper hub opening and a lower hub opening, and a mounting bolt is configured to fit through the upper hub opening, one of the plurality of tension-torsion straps, and the lower hub opening to fasten the tension-torsion strap to the drive hub.

3. The rotor system of claim 2, wherein a center point of the upper hub opening and a center point of the lower hub opening are located at a same distance from the mast axis.

4. The rotor system of claim 1, wherein the rotor system is configured to angle the rotor blades at a range of positions along an asymmetric blade pitch envelope, the asymmetric blade pitch envelope having a maximum blade angle and a minimum blade angle, the maximum blade angle having a greater magnitude than the minimum blade angle.

5. The rotor system of claim 4, wherein the asymmetric blade pitch envelope has a midpoint blade angle midway between the maximum blade angle and the minimum blade angle, and an angle of the mounting axis relative to the mast axis corresponds to the midpoint blade angle.

6. The rotor system of claim 4, wherein:
the rotor blades, when rotating while positioned at the maximum blade angle, apply a first load to the tension-torsion straps;
the rotor blades, when rotating while positioned at the minimum blade angle, apply a second load to the tension-torsion straps; and
an angle of the mounting axis relative to the mast axis is selected such that the first load and the second load have approximately equal magnitude.

7. The rotor system of claim 1, wherein an angle of the mounting axis relative to the mast axis is at least 5°.

8. The rotor system of claim 1, wherein an angle of the mounting axis relative to the mast axis is at least 10°.

9. The rotor system of claim 1, wherein an angle of the mounting axis relative to the mast axis is greater than 15° and less than 20°.

10. A drive hub comprising:
a rotor mast opening extending through a center of the hub body along a mast axis; and
a plurality of mounting slots for mounting tension-torsion straps to the drive hub, the plurality of mounting slots arranged in a circle around the hub body, each mounting slot extending through the hub body along a respective mounting axis, wherein the mounting axis of each of the mounting slots is biased at an angle of at least 5° relative to the mast axis.

11. The drive hub of claim 10, wherein each of the plurality of mounting slots comprises an upper hub opening and a lower hub opening, and a corresponding mounting bolt is configured to fit through the upper hub opening, one of the tension-torsion straps, and the lower hub opening to fasten the tension-torsion strap to the hub body.

12. The drive hub of claim 11, wherein a center point of the upper hub opening and a center point of the lower hub opening are located at a same distance from the mast axis.

13. The drive hub of claim 11, wherein an angle of the mounting axis relative to the mast axis is at least 10°.

14. The drive hub of claim 11, wherein an angle of the mounting axis relative to the mast axis is greater than 15° and less than 20°.

15. An aircraft comprising a ducted tail rotor, the ducted tail rotor comprising:
a drive hub comprising:
a rotor mast opening extending through the drive hub along a mast axis, the drive hub configured to rotate about the mast axis, and
a plurality of mounting slots for mounting tension-torsion straps, the plurality of mounting slots arranged along a circle around the drive hub, each mounting slot extending through the drive hub along a respective mounting axis, wherein the mounting axis of each of the mounting slots is biased relative to the mast axis;
a plurality of rotor blades extending radially from the drive hub;
a plurality of tension-torsion straps connecting the rotor blades to the drive hub, each tension-torsion strap mounted to the drive hub at a corresponding mounting slot; and
a duct surrounding the drive hub and the plurality of rotor blades.

16. The aircraft of claim 15, wherein each of the plurality of mounting slots comprises an upper hub opening and a lower hub opening, and a mounting bolt is configured to fit through the upper hub opening, one of the plurality of tension-torsion straps, and the lower hub opening to fasten the tension-torsion strap to the drive hub.

17. The aircraft of claim 16, wherein a center point of the upper hub opening and a center point of the lower hub opening are located at a same distance from the mast axis.

18. The aircraft of claim 15, wherein the ducted tail rotor is configured to angle the rotor blades at a range of positions along an asymmetric blade pitch envelope, the asymmetric blade pitch envelope having a maximum blade angle and a minimum blade angle, the maximum blade angle having a greater magnitude than the minimum blade angle.

19. The aircraft of claim 18, wherein the asymmetric blade pitch envelope has a midpoint blade angle midway between the maximum blade angle and the minimum blade angle, and an angle of the mounting axis relative to the mast axis corresponds to the midpoint blade angle.

20. The aircraft of claim 18, wherein:
the rotor blades, when rotating while positioned at the maximum blade angle, apply a first load to the tension-torsion straps;
the rotor blades, when rotating while positioned at the minimum blade angle, apply a second load to the tension-torsion straps; and
an angle of the mounting axis relative to the mast axis is selected such that the first load and the second load have approximately equal magnitude.
